(19) United States
(12) Patent Application Publication
(10) Pub. No.: US 2019/0202407 A1
(43) Pub. Date: Jul. 4, 2019

(54) CONTROL APPARATUS AND VEHICLE

(71) Applicant: HONDA MOTOR CO., LTD., Tokyo (JP)

(72) Inventors: Luwei Jia, Wako-shi (JP); Nobuharu Nagaoka, Wako-shi (JP)

(21) Appl. No.: 16/190,945

(22) Filed: Nov. 14, 2018

(30) Foreign Application Priority Data
Dec. 28, 2017 (JP) 2017-254265

(51) Int. Cl. B60S 1/08; B60S 1/34

(52) U.S. Cl. CPC B60S 1/0818; B60S 1/0452; B60S 1/3415

(57) ABSTRACT

A control apparatus that can be mounted on a vehicle which includes an observation apparatus for observing a peripheral environment and a performance recovering apparatus for recovering a performance of the observation apparatus, comprising a predicting unit configured to predict, based on driving information of the vehicle, a degree of performance degradation of the observation apparatus while the vehicle is traveling, and a determination unit configured to determine execution of a driving operation of the performance recovering apparatus based on a prediction result by the predicting unit.

### BACKGROUND OF THE INVENTION

### Field of the Invention

The present invention relates mainly to an onboard control apparatus.

### Description of the Related Art

Among vehicles, there is a vehicle that includes an observation apparatus, such as a camera, radar, LiDAR, or the like for observing the peripheral environment of the vehicle, a cleaning apparatus, and a control apparatus (See Japanese Patent Laid-Open No. 2016-179767). For example, since the performance (observation accuracy) of the observation apparatus will degrade if a piece of dirt adheres to the observation apparatus, the control apparatus will cause the cleaning apparatus to remove the dirt to recover the performance of the observation apparatus and to maintain the performance at a predetermined level.

Since the above-described adherence of dirt does not occur uniformly or at a constant pace, if observation performed by the observation apparatus is disabled by an unpredicted adherence of dirt, it can be assumed that observation of the peripheral environment of the vehicle will not be able to be performed until the dirt is removed by the cleaning apparatus. Hence, in order to maintain the observation apparatus in an observation enabled state, appropriate execution of performance recovery is required. Note that although a washer device and a wiper device are exemplified as cleaning apparatuses in Japanese Patent Laid-Open No. 2016-179767, the above problem is similarly applicable to other apparatuses used for recovering the performance of the observation apparatus.

### SUMMARY OF THE INVENTION

It is an object of the present invention to appropriately execute performance recovery of an observation apparatus.

One of the aspects of the present invention provides a control apparatus that can be mounted on a vehicle which includes an observation apparatus for observing a peripheral environment and a performance recovering apparatus for recovering a performance of the observation apparatus, comprising a predicting unit configured to predict, based on driving information of the vehicle, a degree of performance degradation of the observation apparatus while the vehicle is traveling, and a determination unit configured to determine execution of a driving operation of the performance recovering apparatus based on a prediction result by the predicting unit.

Further features of the present invention will become apparent from the following description of exemplary embodiments with reference to the attached drawings.

### BRIEF DESCRIPTION OF THE DRAWINGS

FIG. 1 is a view for explaining an example of the arrangement of a vehicle;

FIG. 2 is a block diagram for explaining an example of the arrangement of the vehicle;

FIG. 3 is a block diagram for explaining an example of the arrangement of the vehicle;

FIG. 4 is a flowchart for explaining an example of an execution determination method of a performance recovering process;

FIG. 5 is a timing chart for explaining a mode of a determination method according to an embodiment;

FIG. 6 is a timing chart for explaining another mode of the determination method according to the embodiment; and

FIG. 7 is a timing chart for explaining a mode of a determination method according to an embodiment.

### DESCRIPTION OF THE EMBODIMENTS

Embodiments of the present invention will now be described with reference to the accompanying drawings. Note that the drawings are schematic views showing structures or arrangements according to the embodiments, and the dimensions of members shown in the drawings do not necessarily reflect the dimensions of actual members. In addition, the same reference numerals denote the same members or the same constituent elements in the drawings, and a description of repetitive contents will be omitted.

### First Embodiment

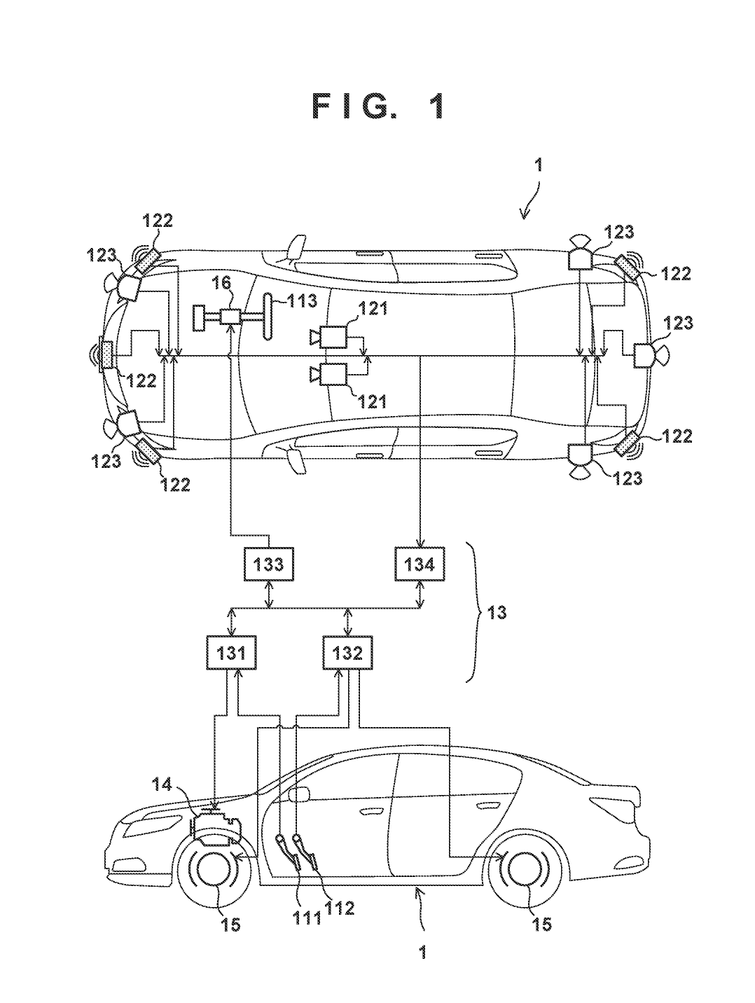

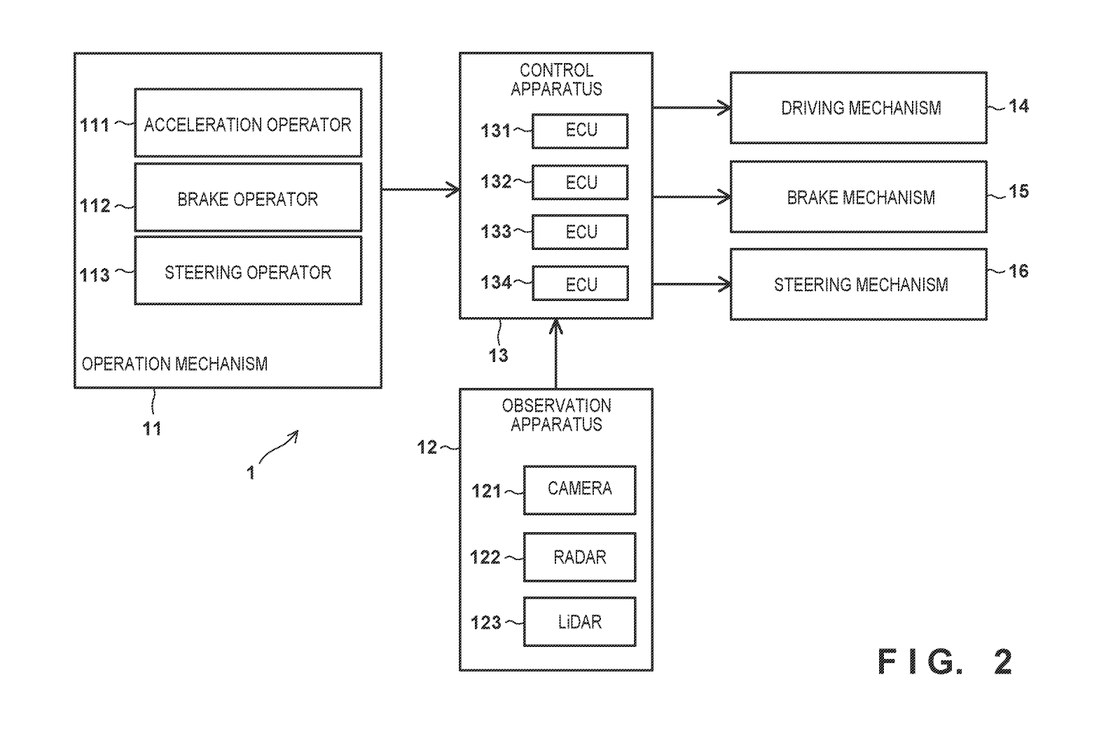

FIGS. 1 and 2 are views for explaining the arrangement of a vehicle 1 according to the first embodiment. FIG. 1 shows the arrangement positions of elements to be described below and the connection relationship between the elements using a plan view and a side view of the vehicle 1. FIG. 2 is a system block diagram of the vehicle 1.

In the following explanation, expressions such as front/rear, upper/lower, and lateral (left/right) are sometimes used. These are used as expressions indicating relative directions based on the vehicle body of the vehicle 1. For example, “front” indicates the front in the longitudinal direction of the vehicle body, and “upper” indicates the height direction of the vehicle body.

The vehicle 1 includes an operation mechanism 11, an observation apparatus 12, a control apparatus 13, a driving mechanism 14, brake mechanisms 15, and a steering mechanism 16. In this embodiment, the vehicle 1 is a four-wheeled vehicle. However, the number of wheels is not limited to this.

The operation mechanism 11 includes an acceleration operator 111, a brake operator 112, and a steering operator 113. Typically, the acceleration operator 111 is an accelerator pedal, the brake operator 112 is a brake pedal, and the steering operator 113 is a steering wheel. However, another type of an operator such as a lever-type or a button-type operator may be used for the operators 111 to 113.

The observation apparatus 12 includes cameras 121, radars 122, and LiDARs (Light Detection and Ranging) 123, all of which function as sensors configured to detect the peripheral environment of the vehicle (self-vehicle) 1. The camera 121 is, for example, an image capturing device using a CCD image sensor, a CMOS image sensor, or the like. The radar 122 is, for example, a distance measuring device such as a millimeter-wave radar. The LiDAR 123 is, for example, a distance measuring device such as a laser radar. These devices are arranged at positions where the peripheral environment of the vehicle 1 can be detected, for example, on the front side, rear side, upper side, and lateral sides of the vehicle body, as shown in FIG. 1.

Examples of the peripheral environment of the vehicle 1 include the driving environment and its related peripheral environments (the extending direction of a lane, a driving permitted region, the color of a traffic light, and the like) of the vehicle 1, object information (the presence/absence of an object such as another vehicle, a pedestrian, or an obstacle, and the attribute, the position, the moving direction, and the speed of the object, and the like) on the periphery of the vehicle 1, and the like. From this point of view, the observation apparatus 12 may be expressed as a detection apparatus for detecting the peripheral information of the vehicle 1.

The control apparatus 13, for example, controls the mechanisms 14 to 16 based on signals from the operation mechanism 11 and/or the observation apparatus 12. The control apparatus 13 includes a plurality of ECUs (Electronic Control Units) 131 to 134. Each ECU includes a CPU, a memory, and a communication interface. Each ECU performs predetermined processing by the CPU based on information (data or an electrical signal) received via the communication interface, and stores the processing result in the memory or outputs the processing result to another element via the communication interface.

In this embodiment, the ECU 131 is an acceleration ECU and, for example, controls the driving mechanism 14 based on the operation amount of the acceleration operator 111 by a driver. The driving mechanism 14 includes, for example, an internal combustion engine and a transmission. The ECU 132 is a brake ECU and, for example, controls the brake mechanism 15 based on the operation amount of the brake operator 112 by the driver. The brake mechanism 15 is, for example, a disc brake provided on each wheel. The ECU 133 is a steering ECU and, for example, controls the steering mechanism 16 based on the operation amount of the steering operator 113 by the driver. The steering mechanism 16 includes, for example, a power steering.

The ECU 134 is analysis ECU provided in correspondence with the observation apparatus 12 and, for example, performs predetermined analysis/processing based on information of the peripheral environment of the vehicle 1 acquired by the observation apparatus 12 and outputs the result to the ECUs 131 to 133. The ECUs 131 to 133 can also control the mechanisms 14 to 16 based on the analysis/processing result from the ECU 134. With this arrangement, the vehicle 1 can perform automated driving corresponding to the peripheral environment of the vehicle 1.

In this specification, automated driving means partially or wholly performing the driving operation (acceleration, braking, and steering) not on the driver side but on the side of the control apparatus 13. That is, the concept of automated driving includes a form in which the driving operation is wholly performed on the side of the control apparatus 13 and a form (so-called driving support) in which the driving operation is only partially performed on the side of the control apparatus 13. Examples of driving support are a vehicle speed control (automatic cruise control) function, a following distance control (adaptive cruise control) function, a lane departure prevention support (lane keep assist) function, a collision avoidance support function, and the like.

Note that the control apparatus 13 is not limited to this arrangement. For example, a semiconductor device such as an ASIC (Application Specific Integrated Circuit) may be used in each of the ECUs 131 to 134. That is, the functions of the ECUs 131 to 134 can be implemented by either hardware or software. In addition, some or all of the ECUs 131 to 134 may be formed by a single ECU.

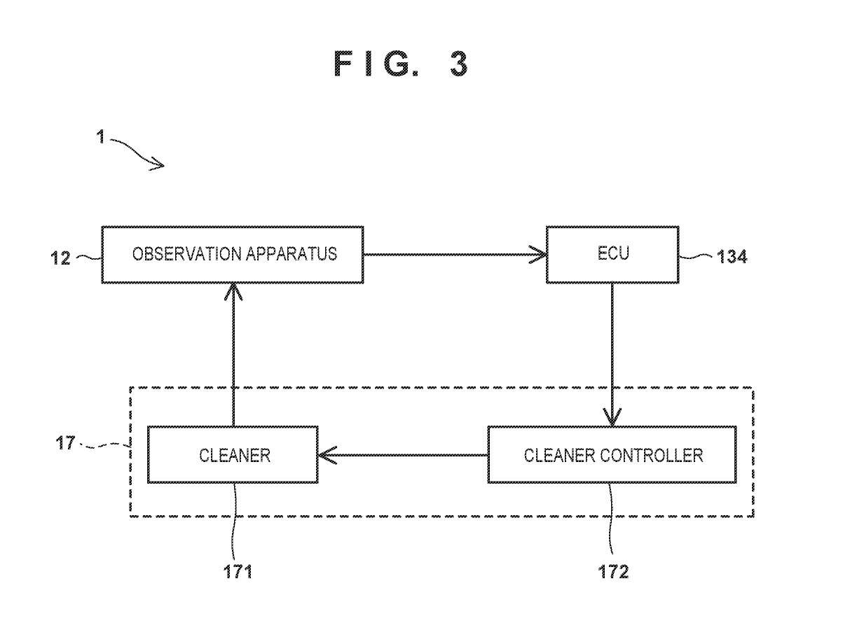

As shown in FIG. 3, the vehicle 1 further includes a performance recovering apparatus 17. The performance recovering apparatus 17 includes cleaners 171 and a cleaner controller 172, and cleans the observation apparatus 12 as a performance recovering process for the recovery of the performance (observation accuracy) of the observation apparatus 12. The cleaner 171 is arranged in correspondence with each of the various types of sensors of the observation apparatus 12, that is, the cameras 121, the radars 122, and the LiDARs 123. Each cleaner 171 recovers the detection performance of the corresponding sensor by spraying washer fluid or gas to and removing the dirt from the detection surface and the exposure surface of the corresponding sensor or its other related elements.

The concept of performance recovery of the observation apparatus 12 includes direct cleaning and the indirect cleaning performed on the observation apparatus 12. For example, in this embodiment, each camera 121 is installed in the vehicle and captures the scene outside the vehicle via the windshield (front window). Hence, the performance recovery of the camera 121 can be executed by removing the dirt that has adhered to the windshield by using a windshield cleaning device, and this corresponds to the above-described indirect cleaning. Examples of the cleaner 171 corresponding to each camera 121 are a washer device that sprays washer fluid on the outer surface of the windshield and a wiper device that removes dirt on the outer surface of the windshield with this washer fluid. Alternatively, a device that prevents or reduces fogging (water droplets which adhere to the vehicle interior surface) of the windshield such as, for example, a heater, an air conditioner, a defroster, or the like can be used as the cleaner 171.

A high pressure washer that sprays gas (or air) for cleaning from a nozzle is also an example of the cleaner 171 corresponding to each of the radars 122 and the LiDARs 123. Alternatively, a washer device, a wiper device, and the like may be used in the same manner as the above-described cameras 121. Note that the same arrangement is also applicable to a case in which the camera 121 is further installed outside the vehicle.

The cleaner controller 172 drives and controls each cleaner 171 based on the control signal from the ECU 134. Note that although the cleaner controller 172 and the ECU 134 have been indicated by separate elements for the sake of discrimination here, these elements may be formed integrally or, alternatively, the cleaner controller 172 may be formed as a single ECU forming a part of the control apparatus 13.

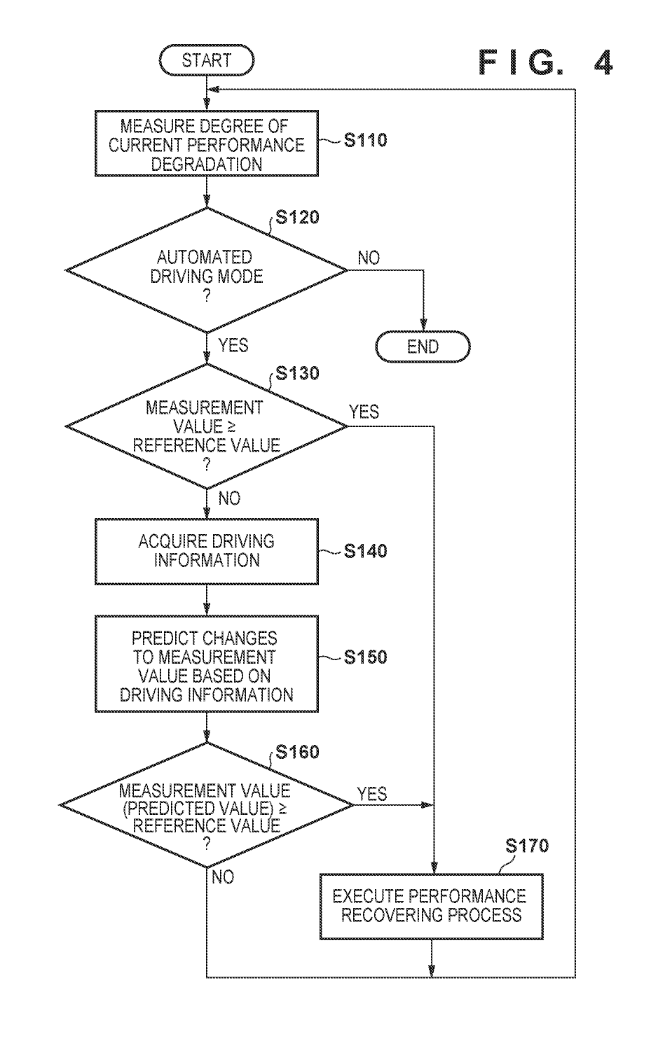

FIG. 4 is a flowchart showing the execution determination method of the performance recovering process of the observation apparatus 12 performed by the performance recovering apparatus 17. The contents of this method are mainly executed by the control apparatus 13 (the ECU 134 in this embodiment) and the performance recovering apparatus 17, and its concept is as follows. That is, in a case in which the measurement result of the degree of performance degradation of the observation apparatus 12 satisfies a predetermined condition, it will be determined that dirt adherence which is equal to or more than a reference value has occurred, and the performance recovering process will be executed. Furthermore, in this embodiment, the possibility that the above-described measurement value will satisfy the same condition within a predetermined period (in the comparatively near future/in a comparatively short period) will be predicted based on the driving information of the vehicle 1, and the performance recovering process will be executed based on this prediction result.

First, in step S110 (to be simply indicated as “S110” hereinafter, and the same also applies to other steps), the (current) measurement value of the degree of performance degradation of the observation apparatus 12 at this point of time is acquired. This measurement point is generated, for example, based on the performance evaluation result of the observation apparatus 12, and is acquired, more specifically, by analyzing the data indicating the peripheral environment of the vehicle 1 received from the observation apparatus 12.

As an example, the detection performance of the camera 121 can be evaluated by performing image analysis on the image data obtained from the camera 121. This evaluation is performed by, for example, determining whether information indicating a piece of dirt (a foreign object such as mud) is included in the image data. More specifically, it can be determined that the adherence of dirt has occurred when a part of/whole group of signals (pixel signals) forming the image data indicates a luminance value which is lower than a reference value. Also, distance information may also be referred to in a case in which the image information includes this information.

The detection performances of the radars 122 and the LiDARs 123 can be evaluated by analyzing the pieces of target information acquired by these devices. For example, the radars 122 acquire the pieces of target information by generating electromagnetic waves (projected waves) and detecting waves (reflected waves) reflected by an object on the periphery of the vehicle 1. This evaluation is, thus, performed by determining whether information indicating a distance of 0 is included in the target information acquired from each of the radars 122, and it can be said that dirt has adhered to the surface of the radar 122 in a case in which the information indicating a distance of 0 is included in the target information. Although the LiDARs 123 mainly differ from the radars 122 in the point that the electromagnetic wave generated by the LiDARs has a shorter wavelength (higher frequency), each LiDAR acquires target information by detecting waves reflected by an object on the periphery of the vehicle 1 in the same manner as the radar 122. Hence, the detection performances of the LiDARs 123 can be evaluated in the same manner as the detection performances of the radars 122.

Note that the above-described measurement value may be acquired by a monitoring apparatus that monitors each type of sensors as another embodiment.

In S120, it is determined whether the vehicle 1 is set to the automated driving mode (an operation mode in which the control apparatus 13 partially/wholly performs the driving operation). If the automated driving mode is set, the process advances to S130. Otherwise, the present sequence ends. Note that the order of S110 and S120 may be switched in accordance with the specification or the like of the automated driving mode.

In S130, it is determined whether the measurement value acquired in S110 is equal to or more than the reference value. If the measurement value is equal to or more than the reference value, it is determined that a corresponding amount of performance degradation has been confirmed in the observation apparatus 12, and the process advances to S170. Otherwise, the process advances to S140.

In S140, the driving information of the vehicle 1 is acquired. This driving information is, for example, the state information of the vehicle 1, the peripheral environment information of the vehicle 1, the information of the scheduled driving route of the vehicle 1, the weather information of the scheduled driving route, the information of the remaining time until the vehicle 1 arrives at the destination, and the like, and may be information that includes at least one of these pieces of information.

An example of the state information of the vehicle 1 is the speed of the vehicle 1, and there is a possibility that the detection performances of the radars 122 and the LiDARs 123 will be influenced in a case in which the vehicle 1 is traveling at a comparatively high speed because dirt can adhere more easily on these devices. The temperature and the humidity inside the vehicle are other examples of the state information of the vehicle 1, and may influence the detection performance of each camera 121 by causing water droplets to adhere on the windshield. The temperature and the humidity outside the vehicle may similarly influence the detection performances the radars 122 and the LiDARs 123 by causing water droplets to adhere to these devices. The execution/non-execution of the driving operations of the wiper device, the heater, the air conditioner, the defroster, and the like is also an example of the state of the vehicle 1, and the degree of the adherence of the above-described water droplets will differ depending on the execution/non-execution of the driving operations of these devices, and the detection performances of the respective types of sensors may be influenced. Hence, these pieces of state information of the vehicle 1 can be used in S150 (to be described later).

The road condition is an example of the peripheral environment information of the vehicle 1, and the detection performances of the cameras 121, the radars 122, and the LiDARs 123 may be influenced by, for example, the presence/absence of rain, snow/ice, mud, sand, or dust on the road surface. Other examples of the peripheral environment information of the vehicle 1 are presence/absence of another/other vehicle(s) around the self-vehicle, the number of this/these other vehicle(s), the distance(s) from this/these other vehicle(s), and the like. If another vehicle is present, there is a possibility that road dust (sand, dust, or the like) kicked up by the other vehicle will influence the detection performances of the cameras 121, the radars 122, and the LiDARs 123. In addition, if the number of other vehicles increases/if the distance from other vehicles decreases, the influence on the above-described detection performances can also increase. Hence, these pieces of peripheral environment information of the vehicle 1 can be used in S150 (to be described later).

A user can input, to the control apparatus 13, information related to the scheduled driving route of the vehicle 1. In a case in which this scheduled driving route includes a road that can induce performance of the observation apparatus 12 to degrade, for example, an unpaved road such as a mountain road, a forest road, or the like, a road near a construction site, or the like, the detection performances of the radars 122 and the LiDARs 123 may be influenced by the inclusion of such a road. Hence, these pieces of information related to the scheduled driving route of the vehicle 1 can be used in S150 (to be described later).

In addition, the amount of rainfall or the amount of snowfall in the scheduled driving route of the vehicle may also influence the detection performances of the radars 122 and the LiDARs 123. Hence, the weather information of the scheduled driving route also can be used in S150 (to be described later). Note that this weather information can be received from a predetermined base station or a public facility or can be received via vehicle-to-vehicle communication or road-to-vehicle communication.

Furthermore, the degree of dirt adherence on each radar 122, each LiDAR 123, or the windshield differs depending on the time remaining until the vehicle 1 arrives at the destination, it may also influence the detection performances of the various types of sensors. Hence, the above-described remaining time can also be used in S150 (to be described later). Note that the above-described remaining time can be calculated based on the scheduled driving route, the speed of the vehicle 1, the congestion state of the scheduled driving route, and the like.

In step S150, the degree of performance degradation of the observation apparatus 12 that can occur within a predetermined period is predicted based on the pieces of driving information acquired in S140, that is, the change from the reference value is predicted by using the measurement value. Since the pieces of driving information acquired in S140 are pieces of information that indicate factors that can influence the performance of the observation apparatus 12, it is possible to appropriately perform the above-described prediction by using these pieces of information.

In S160, whether the measurement value is equal to or more than the reference value will be determined based on the prediction performed in S150. If the measurement value is equal to or more than the reference value, a possibility that a corresponding amount of performance degradation will occur in the observation apparatus 12 within the predetermined period will be determined, and the process advances to S170. Otherwise, the process returns to S110.

In S170, the performance recovering process is executed by driving the performance recovering apparatus 17, and the performance of the observation apparatus 12 is recovered. Subsequently, the process returns to S110.

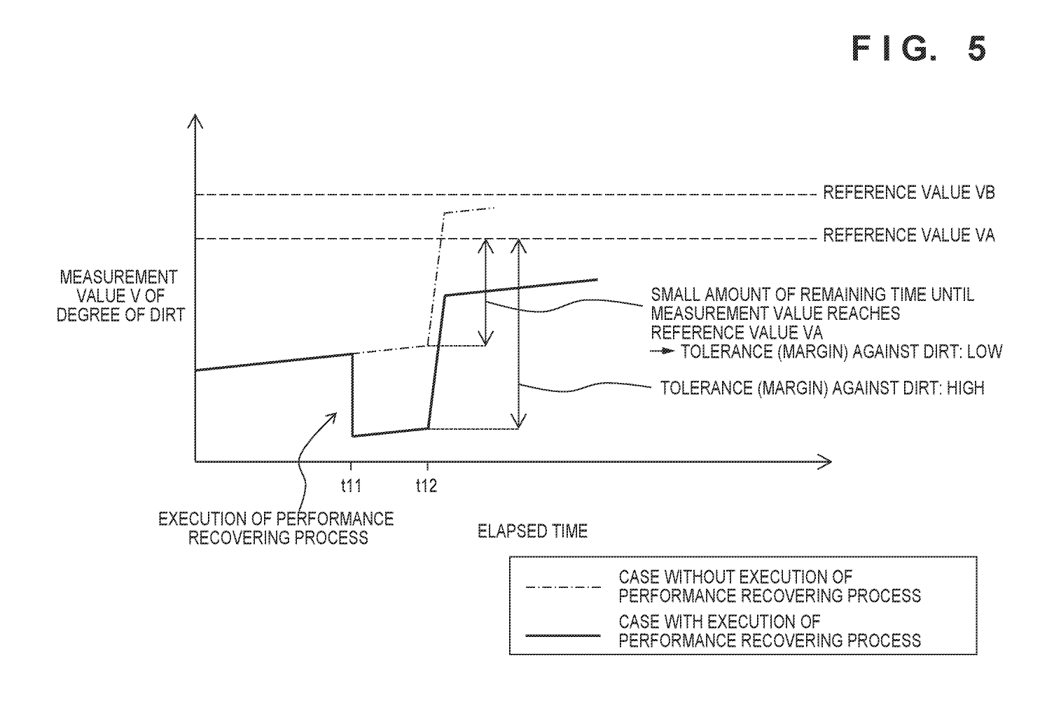

FIG. 5 is a timing chart showing an example of an execution mode of the performance recovering process based on the above-described method. The abscissa of FIG. 5 indicates the elapsed time. The ordinate of FIG. 5 indicates a measurement value (to be referred to as a “measurement value V” hereinafter) acquired in S110. The solid line in FIG. 5 indicates the measurement value V in a case in which the performance recovering process is performed at time t11. The alternate long and short dashed line in FIG. 5 indicates the measurement value V in a case in which the performance recovering process is not performed at time t11.

As shown in FIG. 5, a reference value VA has been set as a threshold for determining the execution/non-execution of the performance recovering process, and a reference value VB (VB>VA) has been set as a value to indicate a tolerance limit of dirt. For example, if the measurement value V has reached the reference value VA, the execution of the performance recovering process is determined (see S130). Also, if the measurement value V has reached the reference value VB, it is determined that the observation apparatus 12 has changed to a state in which it cannot observe the peripheral environment of the vehicle 1, and the automated driving mode is ended in this embodiment. Note that in a case in which the automated driving mode is to be ended, the user such as a driver is informed of this determination, and a signal (a so-called takeover request) indicating that the user needs to be the main controller of the driving operation will be generated.

In this embodiment, it is determined (see S160) that (the predicted value of) the measurement value V will reach the reference value VA at time t12 as a result (see S140 and S150) of the prediction performed at time t11. For example, if it is known beforehand from the driving information acquired in S140 that the vehicle 1 will travel on an unpaved road at time t12, it may be assumed that dirt adherence (or the adherence of comparatively large degree of dirt) may unexpectedly occur at time t12. Hence, in this embodiment, the execution of the performance recovering process is determined (see S170) here at time t11 when the prediction is performed, before time t12 at which the measurement value V can reach the reference value VA. As a result, in contrast to a case in which the measurement value V exceeds the reference value VA at time t12 because the performance recovering process is not performed in advance, it is possible to prevent the measurement value V from exceeding the reference value VA by performing the performance recovering process in advance in this embodiment. In other words, by executing the performance recovering process in advance in a case in which a comparatively large performance degradation of the observation apparatus 12 is predicted, it is possible to ensure, in advance, tolerance (margin) against dirt adherence to the observation apparatus 12.

Although it is predicted in the example of FIG. 5 that the measurement value V will not exceed the reference value VB at time t12 even in a case (indicated by the alternate long and short dashed line in FIG. 5) in which the performance recovering process is not performed, a case in which the measurement value V exceeds the reference value VB at time t12 can be also considered. Hence, in such a case, it is particularly effective to ensure tolerance against the above-described dirt adherence by executing the performance recovering process in advance, and according to this embodiment, executing the performance recovering process in advance can prevent a state in which the measurement value V will reach the reference value VB, and thus the automated driving mode can be continued appropriately.

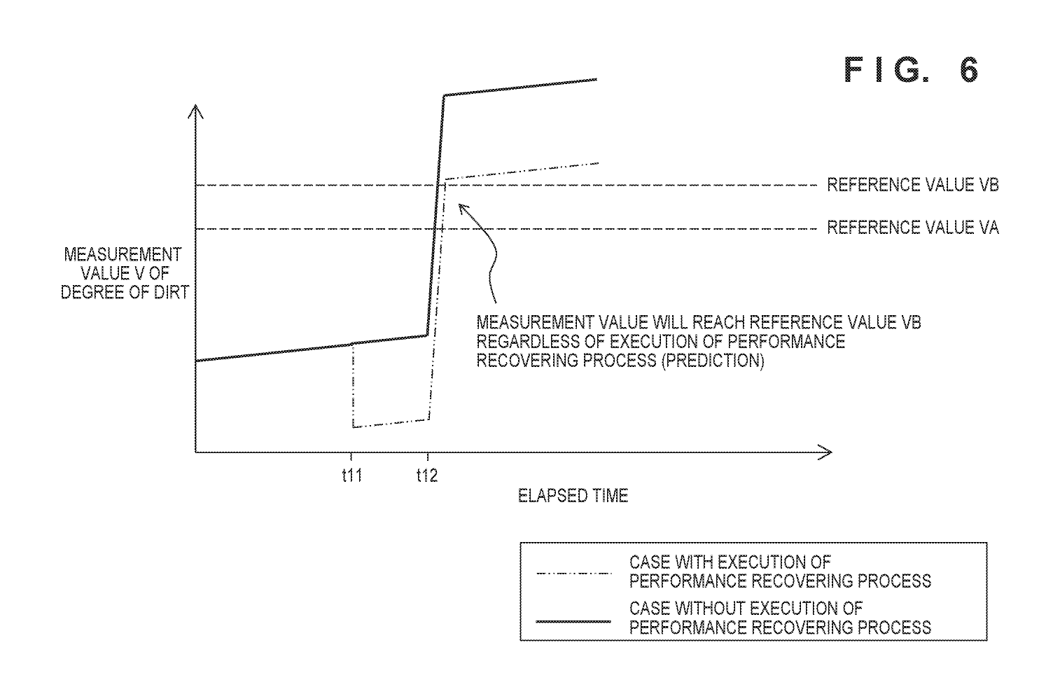

In a case in which the amount of change in the measurement value V can be predicted incidentally at time t12, the execution of the above-described performance recovering process may be determined based on the amount of change from the prediction. FIG. 6 is a timing chart showing another example of the execution mode of the performance recovering process. The alternate long and short dashed line in FIG. 6 indicates the measurement value V in a case in which the performance recovering process is performed at time t11. The solid line in FIG. 6 indicates the measurement value V in a case in which the performance recovering process is not performed at time t11.

In the example of FIG. 6, it is predicted that the measurement value V will exceed the reference value VB at time t12 even in the case (indicated by an alternate long and short dashed line) in which the performance recovering process is performed at time t11. If the measurement value V exceeds the reference value VB regardless of the execution of the performance recovering process, it will be useless to drive the performance recovering apparatus 17. Hence, in such a case, it is preferable to make a determination to suppress the driving of the performance recovering apparatus 17 (not perform the performance recovering process). As a result, for example, useless consumption of consumable parts of the performance recovering apparatus 17 can be suppressed. Note that, in this case, for example, it is preferable to inform the user of the end of the automated driving mode at time t11 (or at least until time t12 at the latest) and generate a takeover request.

Although the example of FIG. 6 assumes that the control apparatus will determine, based on a condition in which the measurement value V exceeds the reference value VB, to suppress the driving operation of the performance recovering apparatus 17 and inform the user of the end of the automated driving mode, this is also applicable to a case based on the establishment of another condition. For example, in a case the measurement value V exceeds the reference value VA a plurality of times within a predetermined period, the performance recovering apparatus 17 will be uselessly driven repeatedly. Hence, in a case in which the number of times that the measurement value V reaches the reference value VA is greater than a predetermined value (for example, a case in which this number of times is greater than 10 times per 1 min), the control apparatus may determine to suppress the driving operation of the performance recovering apparatus 17 and inform the user of the end of the automated driving mode.

As described above, according to this embodiment, the control apparatus 13 predicts, by the ECU 134, the degree of the performance degradation of the observation apparatus 12 of the vehicle 1 during traveling based on the driving information of the vehicle 1. By predicting in advance that the performance of the observation apparatus 12 will degrade in the comparatively near future, it becomes possible to appropriately determine whether to execute the driving operation of the performance recovering apparatus 17, that is, to execute/not execute the performance recovering process in advance. For example, in a case in which dirt adherence has been predicted to occur within a predetermined period during traveling, the performance recovering process can be executed before the occurrence of the dirt adherence to ensure, in advance, tolerance against dirt adherence to the observation apparatus 12.

Although this embodiment exemplified a state (S120) of a case using the automated driving mode, the contents of this embodiment are applicable to other operation modes. For example, the contents of this embodiment are also applicable to an operation mode that is not the automated driving mode, but is an operation mode, that is, a so-called automatic cleaning mode, to start the performance recovering process in accordance with the performance degradation of the observation apparatus 12. For example, since the dirt that has adhered to the windshield is removable by a washer device, a wiper device, and the like, it suffices, in the automatic cleaning mode, for the above-described performance recovering process to be executed in accordance with the degradation of the detection performance of each camera 121. This also similarly applies to the embodiment to be described later.

In addition, in this embodiment, it was assumed that the process will advance to S170 when it is determined in S160 that the measurement value predicted in S150 will be equal to or more than the reference value. That is, if there is a possibility that a corresponding amount of performance degradation will occur in the observation apparatus 12 within a predetermined period, the ECU 134 will drive the cleaner 171 via the cleaner controller 172 and will execute the performance recovering process. However, this operation is not limited to this mode, and the performance recovering process may be executed when an operation indicating the start of the process is directly input by the user. In this case, instead of S170/before S170, the ECU 134 may transmit a message requesting the user to make a required input operation to drive the performance recovering apparatus 17. That is, the ECU 134 will request the user for a performance recovering process instruction. In response to this information, the user can appropriately input this operation to indicate the start of performance recovering process.

### Second Embodiment

The second embodiment differs from the above-described first embodiment mainly in the point that the execution of the performance recovering process is determined based on the past history of a measurement value V. That is, in the second embodiment, a performance recovering process is executed by predicting whether the measurement value V will reach a reference value VA in the comparatively near future based on the past history of the measurement value V.

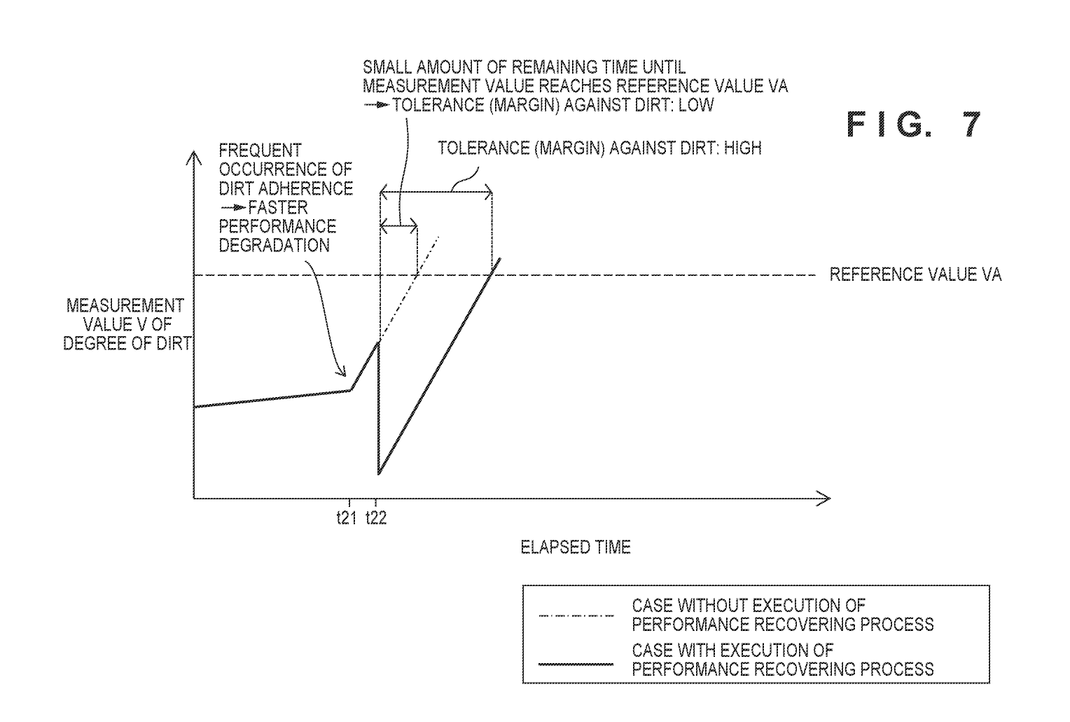

FIG. 7 is a timing chart showing an example of the execution mode of the performance recovering process according to this embodiment. In this embodiment, the amount of change in the measurement value V has increased at time t21. This amount of change can be calculated by the time derivative of the measurement value V. Here, an increase in the amount of change of the measurement value V indicates that a vehicle 1 is being driven in an environment in which dirt adherence can occur easily, and that the performance degradation of an observation apparatus 12 has become faster.

Hence, in this embodiment, in response to the amount of change in the measurement value V reaching a predetermined amount, it is determined, at time t22, to execute the performance recovering process. As can be obvious from FIG. 7, although a case in which the performance recovering process is not executed in advance has little remaining time until the measurement value V reaches the reference value VA, it is possible to ensure the remaining time until the measurement value V reaches the reference value VA by executing the performance recovering process in advance. Therefore, according to this embodiment, the performance recovering process of the observation apparatus 12 can be executed by a comparatively simple method.

### Summary of Embodiments

The first aspect is a control apparatus (for example, 13, 134) that can be mounted on a vehicle (for example, 1) which includes an observation apparatus (for example, 12) for observing a peripheral environment and a performance recovering apparatus (for example, 17) for recovering the performance of the observation apparatus, including a predicting unit (for example, S150) configured to predict, based on driving information of the vehicle, a degree of performance degradation of the observation apparatus while the vehicle is traveling, and a determination unit (for example, S160) configured to determine execution of a driving operation of the performance recovering apparatus based on a prediction result by the predicting unit.

According to the first aspect, performance degradation of the observation apparatus in the comparatively near future during traveling is predicted in advance, and whether to execute/not execute a performance recovering process on the observation apparatus in advance is determined based on this prediction result. For example, in a case in which performance degradation of the observation apparatus due to dirt adherence is predicted to occur within a predetermined period, the performance recovering process can be executed before the occurrence of the dirt adherence so as to ensure tolerance (margin) against the dirt adherence to the observation apparatus in advance.

In the second aspect, the control apparatus further includes an acquisition unit (for example, S120) configured to acquire a measurement value of the degree of the performance degradation, and the determination unit determines the execution of the driving operation of the performance recovering apparatus when (for example, FIG. 5) the predicting unit predicts that the measurement value will reach a reference value (for example, VA) while the vehicle is traveling.

According to the second aspect, the performance recovering process can be executed based on the degree of the performance degradation of the observation apparatus at an arbitrary timing during traveling. Also, in a case in which occurrence of dirt adherence of a degree that can prevent the observation of the peripheral environment is predicted or in a case in which there may be a sudden occurrence of dirt adherence, the performance recovering process can be executed in advance to ensure tolerance against dirt adherence in advance.

In the third aspect, the control apparatus further includes an informing unit configured to inform, when the determination unit has determined the execution of the driving operation of the performance recovering apparatus, a user that the user is required to input an operation for driving the performance recovering apparatus.

According to the third aspect, the control apparatus will request the user to instruct the performance recovering process. The user can appropriately input, in response to this informing operation, an operation to indicate the start of the performance recovering process.

In the fourth aspect, the determination unit determines to suppress, even if the driving operation of the performance recovering apparatus has been executed, the driving operation of the performance recovering apparatus when (for example, FIG. 6) the predicting unit predicts that the measurement value will reach a second reference value (for example VB), which is larger than the reference value, while the vehicle is traveling.

According to the fourth aspect, in a case in which it is predicted that the observation apparatus will not be able to perform an observation operation even if the performance recovering process is executed, the performance recovering process is not executed. As a result, useless driving of the performance recovering apparatus can be avoided.

In the fifth aspect, the determination unit determines to suppress the driving operation of the performance recovering apparatus when the predicting unit predicts that the number of times at which the measurement value will reach the reference value will be larger than a predetermined value.

According to the fifth aspect, in a case in which it is predicted that performance degradation will immediately occur even if the performance recovering process has been executed, this performance recovering process will not be executed. As a result, useless driving of the performance recovering apparatus can be avoided.

In the sixth aspect, the vehicle includes an automated driving mode (S120) as an operation mode, and the control apparatus further includes an informing unit configured to inform a user of the end of the automated driving mode when the determination unit determines to suppress the driving operation of the performance recovering apparatus.

According to the sixth aspect, the above-described control apparatus is suitable for a vehicle which can support the automated driving mode, and can suitably end this automated driving mode and generate a takeover request in a case in which the continuation of the automated driving mode is difficult.

In the seventh aspect, the driving information includes at least one of state information of the vehicle, peripheral environment information of the vehicle, information of a scheduled driving route of the vehicle, weather information of the scheduled driving route, and remaining time until the vehicle arrives at a destination.

According to the seventh aspect, the performance degradation of the observation apparatus can be predicted appropriately. Examples of the state information of the vehicle are the vehicle speed, the temperature and humidity, presence/absence of the driving operation of a wiper device, and the like. Examples of the peripheral environment information of the vehicle are the road condition (presence/absence of rainwater, snow and ice, mud, dust, or the like), presence/absence of another/other vehicle(s) around the self-vehicle, the number of this/these other vehicle(s), the distance(s) from this/these other vehicle(s), and the like. An example of the information of the scheduled driving route is whether there is a plan to travel a road (an unpaved road such as a mountain road or a forest road, a road near a construction site, or the like) that can induce performance degradation of the observation apparatus and the like, and pieces of information related to this can be input beforehand to the control apparatus by the user. The weather information related to this scheduled driving route can be received from a predetermined base station or a public institution or can be received via vehicle-to-vehicle communication or road-to-vehicle communication. In addition, the remaining time until arrival at the destination can be calculated based on the above-described scheduled driving route.

The eighth aspect is a control apparatus (for example, 13, 134) that can be mounted on a vehicle which includes an observation apparatus (for example, 12) for observing a peripheral environment and a performance recovering apparatus (for example, 17) for recovering the performance of the observation apparatus, including an acquisition unit (for example, S120) configured to acquire a measurement value of the degree of performance degradation of the observation apparatus, and a determination unit (for example, FIG. 7) configured to determine execution of a driving operation of the performance recovering apparatus in response to an amount of change in the measurement value reaching a predetermined value.

According to the eighth aspect, when the amount of change in the measurement value of performance degradation of the observation apparatus reaches a predetermined amount, it can be determined that it has become comparatively easier for the performance of the observation apparatus to degrade. By executing the performance recovering process in response to this determination, it is possible to ensure tolerance against dirt adherence to the observation apparatus. Hence, the eighth aspect can obtain the same effect as the first aspect.

In the ninth aspect the observation apparatus includes a camera (for example, 121), radar (for example, 122), and LiDAR (for example, 123).

According to the ninth aspect, the above-described control apparatus can be used to execute the performance recovering processes of various types of observation sensors, and can be mounted on many vehicles which are capable of supporting, for example, the automated driving mode.

In the tenth aspect, the observation apparatus includes a camera (for example, 121) configured to observe the peripheral environment via a windshield, and the performance recovering apparatus includes a windshield cleaning device (for example, 171).

According to the tenth aspect, the observation device is applicable to an on-board camera. Although a washer device, a wiper device, and the like are typical examples of the cleaning device, a heater, an air conditioner, a defroster, and the like are other examples of the cleaning device.

The eleventh aspect is a vehicle that includes a control apparatus, an observation apparatus, and a performance recovering apparatus.

According to the eleventh aspect, it is possible to implement a vehicle that can appropriately execute the performance recovery of the observation apparatus, and it is possible to appropriately implement, for example, a vehicle capable of supporting the automated driving mode.

### Other Embodiments

Several preferred embodiments have been described above. However, the present invention is not limited to these examples and may be modified without departing from the scope of the invention. For example, parts of the contents of the respective embodiments may be combined with each other. In addition, individual terms described in this specification are merely used for the purpose of explaining the present invention, and the present invention is not limited to the strict meanings of the terms and can also incorporate their equivalents.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-254265, filed on Dec. 28, 2017, which is hereby incorporated by reference herein in its entirety.

What is claimed is:

1. A control apparatus that can be mounted on a vehicle which includes an observation apparatus for observing a peripheral environment and a performance recovering apparatus for recovering a performance of the observation apparatus, comprising:
a predicting unit configured to predict, based on driving information of the vehicle, a degree of performance degradation of the observation apparatus while the vehicle is traveling; and
a determination unit configured to determine execution of a driving operation of the performance recovering apparatus based on a prediction result by the predicting unit.

2. The apparatus according to claim 1, wherein the control apparatus further comprises an acquisition unit configured to acquire a measurement value of the degree of the performance degradation, and
the determination unit determines the execution of the driving operation of the performance recovering apparatus when the predicting unit predicts that the measurement value will reach a reference value while the vehicle is traveling.

3. The apparatus according to claim 2, further comprising:
an informing unit configured to inform, when the determination unit has determined the execution of the driving operation of the performance recovering apparatus, a user that the user is required to input an operation for driving the performance recovering apparatus.

4. The apparatus according to claim 2, wherein the determination unit determines to suppress, even if the driving operation of the performance recovering apparatus has been executed, the driving operation of the performance recovering apparatus when the predicting unit predicts that the measurement value will reach a second reference value, which is larger than the reference value, while the vehicle is traveling.

5. The apparatus according to claim 2, wherein the determination unit determines to suppress the driving operation of the performance recovering apparatus when the predicting unit predicts that the number of times at which the measurement value will reach the reference value will be larger than a predetermined value.

6. The apparatus according to claim 4, wherein the vehicle includes an automated driving mode as an operation mode, and
the control apparatus further comprises an informing unit configured to inform a user of the end of the automated driving mode when the determination unit determines to suppress the driving operation of the performance recovering apparatus.

7. The apparatus according to claim 1, wherein the driving information includes at least one of
state information of the vehicle,
peripheral environment information of the vehicle,
information of a scheduled driving route of the vehicle,
weather information of the scheduled driving route, and
information of remaining time until the vehicle arrives at a destination.

8. A control apparatus that can be mounted on a vehicle which includes an observation apparatus for observing a peripheral environment and a performance recovering apparatus for recovering a performance of the observation apparatus, comprising:
an acquisition unit configured to acquire a measurement value of the degree of performance degradation of the observation apparatus; and
a determination unit configured to determine execution of a driving operation of the performance recovering apparatus in response to an amount of change in the measurement value reaching a predetermined value.

9. The apparatus according to claim 1, wherein the observation apparatus comprises a camera, radar, and LiDAR.

10. The apparatus according to claim 1, wherein the observation apparatus comprises a camera configured to observe the peripheral environment via a windshield, and
the performance recovering apparatus comprises a windshield cleaning device.

11. A vehicle comprising:
a control apparatus; an observation apparatus; and a performance recovering apparatus defined in claim 1.
